(19) United States
(12) Patent Application Publication
(10) Pub. No.: US 2024/0337440 A1
(43) Pub. Date: Oct. 10, 2024

(54) SYSTEMS AND METHODS FOR CHILLING A NATURAL GAS STREAM

(71) Applicant: SAUDI ARABIAN OIL COMPANY, Dhahran (SA)

(72) Inventors: Mutlaq F. AZMI, Tanajib (SA); Shahid M. ALHINDI, Tanajib (SA); Abdullah S. ALHUSSAIN, Tanajib (SA)

(73) Assignee: SAUDI ARABIAN OIL COMPANY, Dhahran (SA)

(21) Appl. No.: 18/298,273

(22) Filed: Apr. 10, 2023

(51) Int. Cl. F25J 1/00; F25J 1/02

(52) U.S. Cl. CPC F25J 1/0022; F25J 1/0052; F25J 1/0282; F25J 1/008; F25J 2210/60; F25J 2215/04; F25J 2270/12

(57) ABSTRACT

Methods for chilling a natural gas stream may comprise: obtaining an expanded natural gas stream from an outlet of an expander, in which the expanded natural gas stream has a lower temperature and pressure than does the natural gas stream; introducing at least a portion of the expanded natural gas stream to a heat exchanger to promote indirect thermal communication between the expanded natural gas stream or a portion thereof and an external refrigerant circulating through the heat exchanger by way of a cooling loop; obtaining a chilled natural gas stream from the heat exchanger; introducing the chilled natural gas stream to a cold separator; and obtaining from the cold separator a further chilled natural gas stream as an overhead stream. The cooling loop comprises at least one compressor, and the expander supplies at least a portion of the power needed to operate the at least one compressor.

### FIELD OF THE DISCLOSURE

The present disclosure relates generally to processing of natural gas streams and, more particularly, to systems and methods for more effectively chilling natural gas streams using a cooling loop containing an external refrigerant.

### BACKGROUND OF THE DISCLOSURE

Natural gas is a hydrocarbon resource comprising predominantly methane, as well as lesser amounts of heavier hydrocarbons, such as ethane, propane, butane, pentane, and isomers thereof. Minor amounts of water, nitrogen, iron sulfide, and wax, for example, as well as other impurities, may also be present in a natural gas stream obtained from a given source. A raw natural gas stream may be processed to at least partially separate methane from the heavier hydrocarbons and other components, wherein the methane may ultimately undergo liquefaction and be sold as liquefied natural gas (LNG). In some cases, a raw natural gas stream may be further processed without undergoing liquefaction to form LNG. In the course of forming LNG or otherwise being further processed, a raw natural gas stream may undergo various stages of cooling to bring the natural gas to a desired set of temperature and pressure conditions.

In some instances, at least one stage of cooling a natural gas stream may utilize a cooling loop containing an external refrigerant, which may promote condensation of at least a portion of the natural gas. Conversion of at least a portion of the natural gas stream to a liquid state may be referred to as “dew pointing” the natural gas. The condensed portion of the natural gas stream may constitute heavier hydrocarbons and other less volatile components present in a raw natural gas stream, which are often desirable to separate from methane and other light components of natural gas.

FIG. 1 is a block diagram of a conventional system and method for chilling a natural gas stream using a cooling loop containing an external refrigerant. As shown, system and method 100 introduces natural gas stream 102 into heat exchanger 104, wherein natural gas stream 102 is cooled using an external refrigerant circulating within cooling loop 110. Within heat exchanger 104, the external refrigerant is in a liquefied state and indirectly contacts natural gas stream 102. After undergoing heating and exiting heat exchanger 104, the external refrigerant within line 111 of cooling loop 110 is in an at least partially gasified (vaporized) state. The at least partially gasified external refrigerant then passes to cooling loop separator 112 (e.g., a gas-liquid separator, such as a knockout drum) to remove any liquid condensate prior to discharging an overhead stream containing gasified external refrigerant to compressor 116 via line 117. Compressor 116 raises the pressure and temperature of the gasified external refrigerant. After the resulting compressed external refrigerant exits compressor 116 via line 119, the compressed external refrigerant enters condenser 120 and undergoes cooling to regenerate liquefied external refrigerant. The liquefied external refrigerant exits condenser 120 via line 121 and proceeds to surge tank 122. Thereafter, the liquefied external refrigerant exits surge tank 122 via line 125 and returns to heat exchanger 104 to provide a closed loop refrigeration cycle.

Referring still to FIG. 1, a chilled natural gas stream exits heat exchanger 104 via line 141 and enters cold separator 144 (e.g., a gas-liquid separator, such as a knockout drum), wherein the chilled natural gas stream is flashed and separated into a further chilled natural gas stream and a condensed liquid stream. The further chilled natural gas stream is removed from cold separator 144 as an overhead stream via line 145, wherefrom the further chilled natural gas stream may undergo subsequent processing and/or additional chilling downstream (e.g., to form LNG, further process details not shown). The condensed liquid stream is removed from cold separator 144 as a bottoms stream and exits system and method 100 via line 147. The condensed liquid stream in line 147 may sometimes undergo further processing to recover other value components therein as well. Although the foregoing may be effective for chilling an incoming natural gas stream, even more effective natural gas processing may be desirable.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to embodiments consistent with the present disclosure, methods for chilling a natural gas stream may comprise: introducing a natural gas stream to an expander; obtaining an expanded natural gas stream from an outlet of the expander, the expanded natural gas stream having a lower temperature and a lower pressure than does the natural gas stream; introducing at least a portion of the expanded natural gas stream to a heat exchanger, the heat exchanger promoting indirect thermal communication between the expanded natural gas stream or a portion thereof and an external refrigerant circulating through the heat exchanger by way of a cooling loop; obtaining a chilled natural gas stream from an outlet of the heat exchanger; introducing the chilled natural gas stream to a cold separator; and obtaining from the cold separator a further chilled natural gas stream as an overhead stream and a first condensed liquid stream as a bottoms stream. The cooling loop comprises at least one compressor, and the expander directly or indirectly supplies at least a portion of an amount of power needed to operate the at least one compressor.

According to some or other embodiments consistent with the present disclosure, systems for processing a natural gas stream may comprise: an expander configured to receive a natural gas stream; a heat exchanger in fluid communication with an outlet of the expander and configured to receive an expanded natural gas stream therefrom, an external refrigerant circulating through the heat exchanger by way of a cooling loop having at least one compressor located therein, the external refrigerant being in indirect thermal communication with the expanded natural gas stream to produce a chilled natural gas stream; and a cold separator in fluid communication with an outlet of the heat exchanger and configured to receive the chilled natural gas stream from the heat exchanger and to discharge a further chilled natural gas stream as an overhead stream and a first condensed liquid stream as a bottoms stream. The expander directly or indirectly supplies at least a portion of an amount of power needed to operate the at least one compressor.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 (PRIOR ART) is a block diagram of a conventional system and method for chilling a natural gas stream using a cooling loop containing an external refrigerant.

FIGS. 2A and 2B are block diagrams of systems and methods of the present disclosure for chilling a natural gas stream using a cooling loop containing an external refrigerant, wherein the natural gas stream is precooled by expansion and an expander is directly coupled to at least one compressor by a shaft.

FIGS. 3A and 3B are block diagrams of systems and methods of the present disclosure for chilling a natural gas stream using a cooling loop containing an external refrigerant, wherein the natural gas stream is precooled by expansion and an expander produces power via a generator for operating at least one compressor.

### DETAILED DESCRIPTION

Embodiments in accordance with the present disclosure generally relate to processing of natural gas streams and, more particularly, to systems and methods for more effectively chilling natural gas streams using a cooling loop containing an external refrigerant.

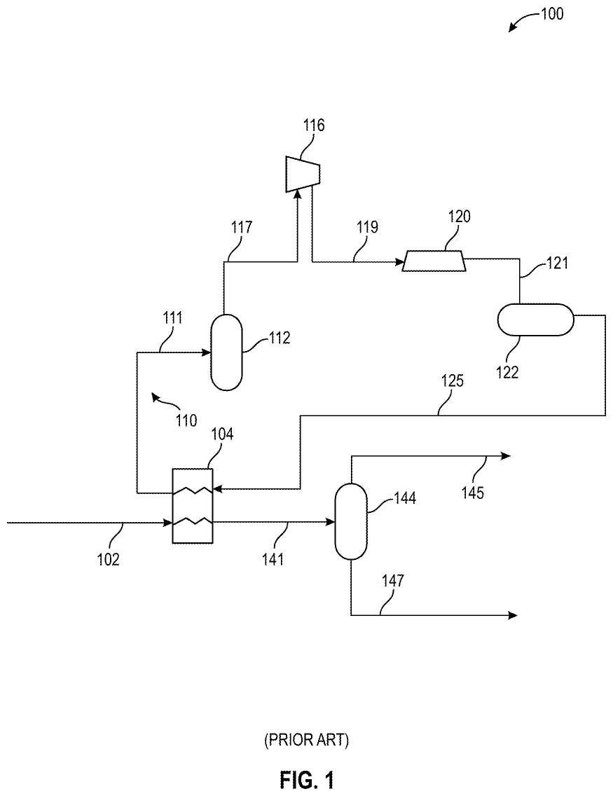

Natural gas streams are processed in various manners to make the natural gas suitable for transportation or for consumer distribution or use. The natural gas stream is often converted into liquefied natural gas (LNG) for transport, frequently after being processed to separate heavier hydrocarbons and other undesired components from methane. Similar processing may occur for a natural gas stream not being converted to LNG. In the course of being converted to LNG or otherwise being processed, a natural gas stream may undergo various stages of cooling. The cooling may employ a cooling loop containing an external refrigerant. While a wide range of techniques are applicable for cooling a natural gas stream using a cooling loop containing an external refrigerant (system and method 100 in FIG. 1 is an illustrative example), even small improvements in cooling efficiency may reap significant gains in energy usage and process economics, in view of the massive volumes of natural gas undergoing processing on a daily basis worldwide.

The present disclosure addresses the foregoing by improving the efficiency of system and method 100 (FIG. 1) by precooling a natural gas stream through expansion and an accompanying pressure decrease prior to performing heat exchange with a cooling loop containing an external refrigerant. Upon undergoing expansion, the temperature and pressure of the natural gas stream drops according to Amonton's Law (also known as Gay-Lussac's Law), which states that the pressure of a gas is directly proportional to the Kelvin temperature of the gas. By precooling a natural gas stream through expansion and partial depressurization, the cooling duty of heat exchanger 104 may be reduced. Moreover, because expanders may produce work in the course of expanding a gas, the work produced by the expander may be provided to compressor 116 in cooling loop 110 in the presently described systems and methods, thereby supplying at least a portion of an amount of power needed during operation for compressing the external refrigerant therein. Collectively, these additions may decrease energy usage and resulting process economics. Additional details are provided hereinafter.

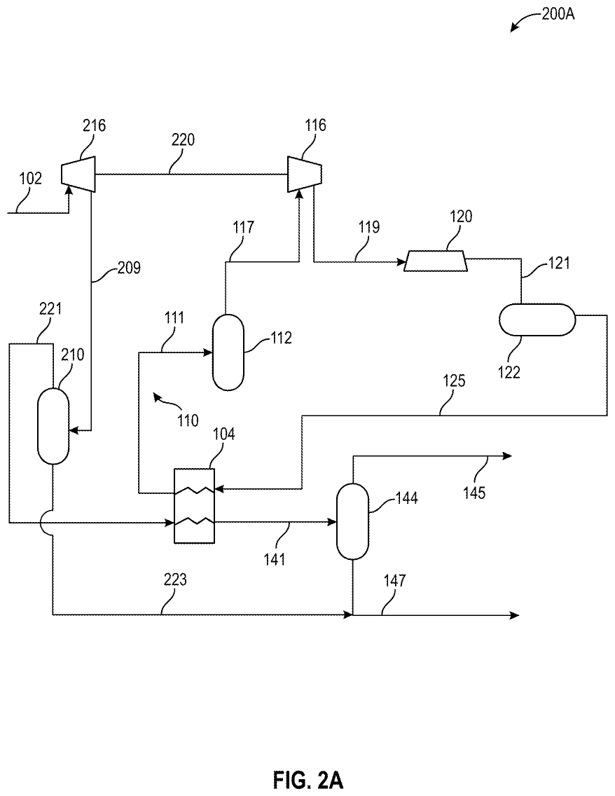

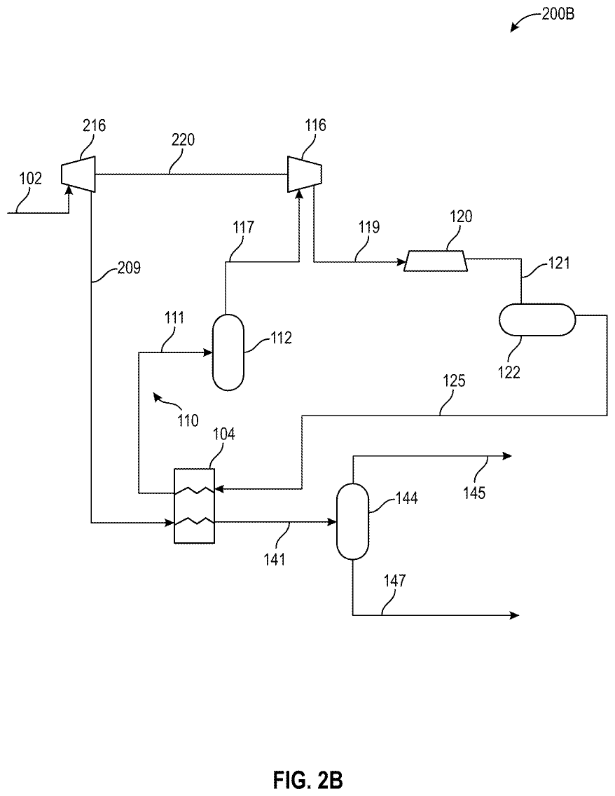

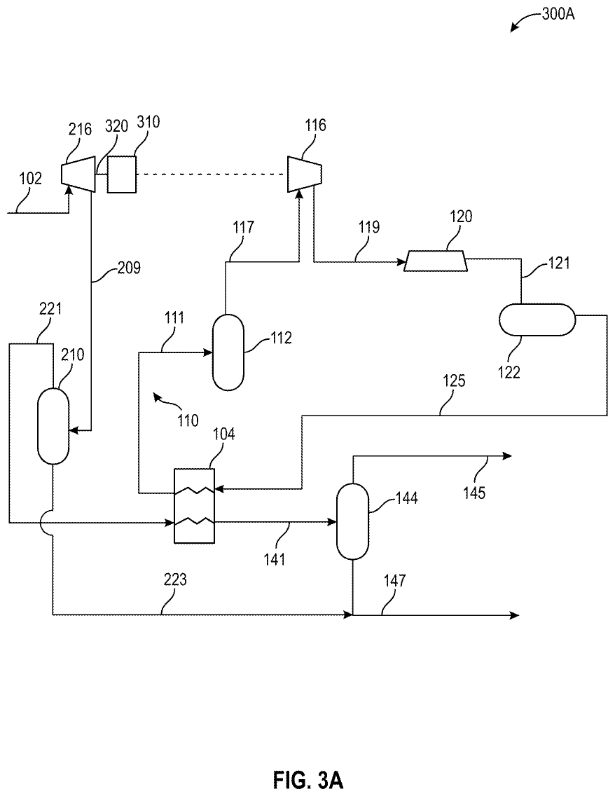

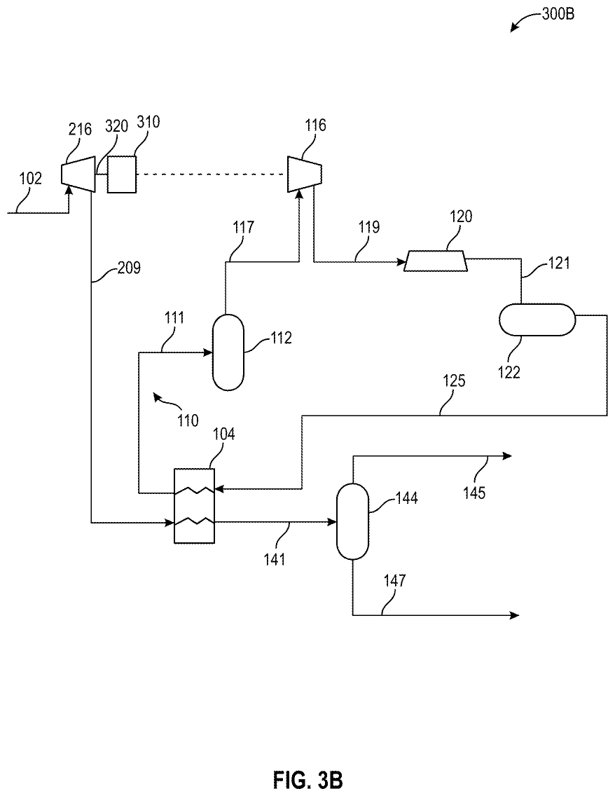

Embodiments of the present disclosure will now be described in detail with reference to FIGS. 2A, 2B, 3A, and 3B of the drawings. In-common reference characters are used in the drawings to designate elements having similar structures and/or fulfilling similar purposes in multiple drawings. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the drawings may vary without departing from the scope of the present disclosure.

FIG. 2A is a block diagram of a first embodiment of a system and method for cooling a natural gas stream using a cooling loop containing an external refrigerant according to the present disclosure, wherein the natural gas stream is precooled by expansion. The expansion facilitates an accompanying pressure decrease, thereby also decreasing the temperature of the natural gas stream prior to further cooling using the external refrigerant. System and method 200A in FIG. 2A represents a modification of system and method 100 in FIG. 1 and may be better understood by reference thereto. Specifically, system and method 200A in FIG. 2A differs from system and method 100 in FIG. 1 in two main aspects, as discussed subsequently. Elements of system and method 200A in FIG. 2A operating in a similar manner to those in system and method 100 in FIG. 1 are not discussed again in detail in the interest of brevity.

In a first aspect differing from system and method 100 (FIG. 1), rather than introducing natural gas stream 102 directly to heat exchanger 104, natural gas stream 102 is first introduced to expander 216 to produce an expanded natural gas stream that then proceeds to an inlet of warm separator 210 (e.g., a gas-liquid separator, such as a knockout drum) via line 209. The expanded natural gas stream has a lower temperature and a lower pressure than does natural gas stream 102. Depending on the temperature and pressure of natural gas stream 102 and the pressure drop occurring in expander 216, the expanded natural gas stream in line 209 may be fully in a gasified (vaporized) state or at least partially in a liquefied state. Warm separator 210 may facilitate separation of a precooled natural gas stream from a condensed liquid stream after the expanded natural gas stream is introduced from line 209 and flashed therein. As shown, the precooled natural gas stream may exit warm separator 210 as an overhead stream via line 221 and subsequently enter an inlet of heat exchanger 104. After subsequently exiting heat exchanger 104, the resulting chilled natural gas stream is additionally processed in cold separator 144 (e.g., a gas-liquid separator, such as a knockout drum) in a similar manner to that described above in reference to system and method 100 in FIG. 1. By reducing the pressure and temperature of natural gas stream 102 via expander 216 to form the expanded natural gas stream, the required cooling duty for heat exchanger 104 may be decreased. Moreover, because of the decreased cooling duty, the circulation rate of the external refrigerant in cooling loop 110 may be lessened. Lower temperatures of the chilled natural gas stream in line 141 may also be realized. The lower temperatures of the chilled natural gas stream may facilitate subsequent liquefaction thereof.

The condensed liquid stream (if any) produced in warm separator 210 exits therefrom via line 223. Line 223 may join with line 147, which carries the condensed liquid stream obtained from cold separator 144. The resulting combined condensed liquid stream may be subsequently processed together (additional details not shown).

Optionally, if the expanded natural gas stream in line 209 is in a fully gasified (vaporized) state or near fully gasified state, warm separator 210 and line 223 may be omitted (or may be bypassed via a bypass line-not shown), in which case line 209 may convey the expanded natural gas stream directly to an inlet of heat exchanger 104, wherein the expanded natural gas stream may again be precooled by expansion. FIG. 2B is a block diagram of a second embodiment of a system and method for cooling a natural gas stream using a cooling loop containing an external refrigerant according to the present disclosure, wherein the natural gas stream is precooled by expansion. System and method 200B in FIG. 2B differs from system and method 200A in FIG. 2A in the omission of expander knockout drum 210 and line 223 and the direct connection of line 209 to an inlet of heat exchanger 104.

In a second aspect differing from system and method 100 (FIG. 1), expander 216 may directly or indirectly supply at least a portion of an amount of power needed to operate compressor 116 within cooling loop 110. Expander 216 may directly supply power to compressor 116 by being operatively coupled thereto via a shaft or indirectly by producing power via a generator, with the power or a portion thereof then being supplied to compressor 116.

As shown in FIGS. 2A and 2B, expander 216 may directly supply power to compressor 116 by being operatively coupled to compressor 116 within cooling loop 110 via shaft 220. The coupled entity of expander 216, shaft 220, and compressor 116 may be referred to as a turboexpander. Expander 216 produces work in the course of forming the expanded natural gas stream, thereby turning shaft 220. Shaft 220 may then transfer the work to compressor 116.

Alternately, as shown in FIGS. 3A and 3B, expander 216 may indirectly supply power to compressor 116 by first converting work to power in generator 310. For example, expander 216 may be operatively coupled to generator 310 by shaft 320. As shaft 320 turns in the course of forming the expanded natural gas stream, power may be produced by generator 310. The power or a portion thereof may then be supplied to compressor 116 to facilitate operation thereof.

By coupling expander 216 directly or indirectly to compressor 116, work produced by expander 216 in forming the expanded natural gas stream may be utilized to supply at least a portion of an amount of power needed to operate compressor 116 within cooling loop 110. In non-limiting examples, an external power source (not shown) may be coupled to compressor 116. The external power source may supply power to compressor 116 during at least system startup. After expander 216 is operating and producing work, all or a portion of the power supplied by the external power source to compressor 116 may be withdrawn. Preferably, after a startup period in which power is supplied to compressor 116 solely from an external power source, all or at least a substantial majority of the power required for the operation of compressor 116 may be supplied from the work produced in expander 216. Other than receiving at least a portion of the power to compressor 116 from expanded 216, the operation of cooling loop 110 in FIGS. 2A, 2B, 3A, and 3B is similar to that described above in reference to system and method 100 in FIG. 1.

Thus, by incorporating expander 216 upstream from heat exchanger 104 and additionally coupling expander 216 to compressor 116 within cooling loop 110 to supply power thereto, more efficient operation of cooling loop 110 and production of the chilled natural gas stream in line 141 may be realized. The foregoing may be facilitated by taking advantage of the excess pressure present in the as-obtained source of natural gas stream 102.

Cooling loop 110 defines a closed circulation pathway containing an external refrigerant to promote cooling within heat exchanger 104. The term “external refrigerant” means the refrigerant circulating in cooling loop 110 is not provided from natural gas stream 102 or a cooled or chilled variant thereof (e.g., no self-refrigeration). The external refrigerant circulating in cooling loop 110 may be a single refrigerant or a mixed refrigerant. In non-limiting examples, the external refrigerant in cooling loop 110 may comprise one or more of a hydrocarbon (e.g., methane, ethane, propane, butane, isobutane, pentane, isopentane, the like, and any combination thereof), a fluorocarbon refrigerant (inclusive of fluorocarbons, hydrofluorocarbons, hydrochlorofluorcarbons, chlorofluorocarbons, hydrofluoroolefins, and the like) or any combination thereof. Other refrigerants such as liquid nitrogen, carbon dioxide, or ammonia may also be suitable in some instances.

Heat exchanger 104 may define any structure within which the external refrigerant circulating in cooling loop 110 may accept excess heat through thermal communication with the expanded natural gas stream or a precooled natural gas stream obtained therefrom. The external refrigerant and the expanded natural gas stream may be in indirect thermal contact within heat exchanger 104. That is, the expanded natural gas stream and the external refrigerant do not physically intermix with one another. As shown, heat exchanger 110 includes discrete channels or flow pathways through which the expanded natural gas stream and the external refrigerant may flow. It is to be appreciated, however, that the depicted configuration is illustrative in nature, and other heat exchanger configurations may also be applicable. For example, in some instances, a tube-in-shell heat exchanger may also be suitable, wherein one or more tubes carrying the expanded natural gas stream may be surrounded by a circulating “bath” of external refrigerant supplied from cooling loop 110.

It is to be appreciated that the drawings may omit certain additional components to facilitate operation thereof. Non-limiting examples of such components may include, but are not limited to, valves, pumps, additional heat exchangers, and the like. Placement and operation of such components will be familiar to one having ordinary skill in the art.

Accordingly, systems for chilling a natural gas stream (e.g., dew pointing the natural gas stream) may comprise: an expander configured to receive a natural gas stream; a heat exchanger in fluid communication with an outlet of the expander and configured to receive an expanded natural gas stream therefrom; and a cold separator in fluid communication with an outlet of the heat exchanger and configured to receive a chilled natural gas stream from the heat exchanger and to discharge a further chilled natural gas stream as an overhead stream and a first condensed liquid stream as a bottoms stream. An external refrigerant circulates through the heat exchanger by way of a cooling loop having at least one compressor located therein, in which the external refrigerant is in indirect thermal communication with the expanded natural gas stream to produce the chilled natural gas stream. The expander directly or indirectly supplies at least a portion of an amount of power needed to operate the at least one compressor.

The systems may further comprise a warm separator in fluid communication with an outlet of the expander and configured to receive the expanded natural gas stream therefrom. A first outlet of the warm separator is configured to discharge the expanded natural gas stream as an overhead stream and provide the expanded natural gas stream to the heat exchanger. A second outlet of the warm separator is configured to discharge a condensed liquid stream as a bottoms stream from the warm separator.

Further, methods for processing a natural gas stream to produce a chilled natural gas stream according to the present disclosure may comprise: introducing a natural gas stream to an expander; obtaining an expanded natural gas stream from an outlet of the expander, in which the expanded natural gas stream has a lower temperature and a lower pressure than does the natural gas stream; introducing at least a portion of the expanded natural gas stream to a heat exchanger, in which the heat exchanger promotes indirect thermal communication between the expanded natural gas stream or a portion thereof and an external refrigerant circulating through the heat exchanger by way of a cooling loop, and the cooling loop comprises at least one compressor; obtaining a chilled natural gas stream from an outlet of the heat exchanger; introducing the chilled natural gas stream to a cold separator; and obtaining from the cold separator a further chilled natural gas stream as an overhead stream and a first condensed liquid stream as a bottoms stream. The expander may directly or indirectly supply at least a portion of an amount of power needed to operate the at least one compressor within the cooling loop.

Optionally but preferably, the expanded natural gas stream may pass through a warm separator before being introduced to the heat exchanger. An overhead stream from the warm separator is then introduced to the heat exchanger as a precooled natural gas stream. A bottoms stream comprising a second condensed liquid stream may be obtained from the warm separator. Optionally, the second condensed liquid stream may be combined with the first condensed liquid stream downstream from the cold separator.

In addition to the compressor, the cooling loop may further comprise a cooling loop separator, a condenser, and a surge tank that are in fluid communication with one another. The cooling loop separator is upstream from the compressor, and the condenser and the surge tank are downstream from the compressor, in that order. Thus, after leaving the heat exchanger, an external refrigerant in the cooling loop flows sequentially through the cooling loop separator, the compressor, the condenser, and the surge tank before returning to the heat exchanger. After leaving the heat exchanger, the external refrigerant may be at least partially vaporized. Separation of vaporized external refrigerant from a residual liquid phase may occur in the cooling loop separator. The compressor receives the vaporized external refrigerant from the cooling loop separator, and the compressor and the condenser may collectively re-form liquefied external refrigerant, which is then collected in the surge tank. The liquefied external refrigerant in the surge tank is then recirculated to the heat exchanger to perform additional cooling.

The natural gas stream may comprise methane and one or more condensable impurities in vaporized (gaseous) form. At least a portion of the condensable impurities may comprise hydrocarbons heavier than methane, such as ethane, ethylene, propane, propylene, butane, butylene(s), pentane, or any combination thereof. Preferably, methane is the majority component of the natural gas stream. In general, the temperature and pressure of the natural gas stream are outside the control of a plant operator. As such, the temperature and pressure of the natural gas stream may vary over a considerable range. In non-limiting examples, the temperature of the natural gas stream may range from about 80° F. to about 120° F. (26.7° C. to 48.9° C.), or about 85° F. to about 105° F. (29.4° C. to 40.6° C.), or about 90° F. to about 100° F. (32.2° C. to 37.8° C.), or about 95° F. to about 110° F. (35° C. to 43.3° C.). In some or other non-limiting examples, the pressure of the natural gas stream may range from about 400 psi to about 800 psi (2.76 MPa to 5.52 MPa), or about 450 psi to about 700 psi (3.10 MPa to 4.83 MPa), or about 475 psi to about 600 psi (3.28 MPa to 4.14 MPa), or about 475 psi to about 525 psi (3.28 MPa to 3.62 MPa), or about 450 psi to about 550 psi (3.10 MPa to 3.79 MPa).

After undergoing expansion in the expander, the temperature and pressure of the resulting expanded natural gas stream may decrease relative to the incoming natural gas stream. In non-limiting examples, the temperature of the expanded natural gas stream may range from about 75° F. to about 90° F. (23.9° C. to 32.2° C.), or about 80° F. to about 90° F. (26.7° C. to 32.2° C.), or about 75° F. to about 85° F. (23.9° C. to 29.4° C.). In some or other non-limiting examples, the pressure of the expanded natural gas stream may range from about 350 psi to about 750 psi (2.41 MPa to 5.17 MPa), or about 400 psi to about 650 psi (2.76 MPa to 4.48 MPa), or about 425 psi to about 550 psi (2.93 MPa to 3.79 MPa), or about 425 psi to about 475 psi (2.93 MPa to 3.28 MPa), or about 400 psi to about 500 psi (2.76 MPa to 3.45 MPa).

The pressure change occurring upon expanding the natural gas stream in the expander and obtaining an expanded natural gas stream therefrom may correlate with the amount of power that is produced by the expander for operating the compressor in the cooling loop. The throughput of the natural gas stream through the expander may also determine the amount of power that is produced. In non-limiting examples, the pressure drop may range from about 25 psi to about 60 psi (0.17 MPa to 0.41 MPa), or about 30 psi to about 50 psi (0.21 MPa to 0.34 MPa), or about 40 psi to about 60 psi (0.28 MPa 0.41 MPa), or about 45 psi to about 55 psi (0.31 MPa to 0.38 MPa). The flow rate of the natural gas stream may range from about 180 mscf/day (5.1×10⁹ L/day) to about 275 mscf/day (7.8×10⁹ L/day) (mscf=million standard cubic feet). At these pressure drop and throughput values, the amount of power produced by the expander for operating the compressor(s) within the cooling loop may range from about 800 hp to about 1200 hp (73.6 kW to 147.1 kW), or about 900 hp to about 1100 hp (662.0 kW to 809.1 kW), or about 950 hp to about 1050 hp (698.7 kW to 772.3 kW). In some examples, the expander may produce at least about 50% of the amount of power needed for operating the compressor(s) in the cooling loop, or at least about 60% of the power, or at least about 70% of the power, or at least about 80% of the power, or at least about 90% of the power, or at least about 95% of the power. In some instances, following a startup period, the expander may produce sufficient power to operate the compressor(s) in the cooling loop without using an external power source.

The chilled natural gas stream obtained from the heat exchanger may similarly vary over a range of temperatures and pressures. In non-limiting examples, the pressure of the chilled natural gas stream may be within about 10% of the pressure of the expanded natural gas stream or the precooled natural gas stream received by the heat exchanger, or within about 6% of the pressure of the expanded natural gas stream or the precooled natural gas stream, or within about 4% of the pressure of the expanded natural gas stream or the precooled natural gas stream, or within about 2% of the pressure of the expanded natural gas stream or the precooled natural gas stream. For example, the additional pressure drop may be about 10 psi or less (0.068 MPa or less). Accordingly, the expanded natural gas stream produced by the expander may undergo minimal additional depressurization upon being flashed in the warm separator (e.g., warm separator 210) and undergoing heat exchange in the heat exchanger. The temperature of the chilled natural gas stream following heat exchange may be lower than that of the expanded natural gas stream or the precooled natural gas stream. In non-limiting examples, the temperature of the chilled natural gas stream following heat exchange may range from about 60° F. to about 75° F. (15.6° C. to 23.9° C.), or about 65° F. to about 70° F. (18.3° C. to 21.1° C.), or about 68° F. to about 72° F. (20.0° C. to 22.2° C.).

Embodiments disclosed herein include:

A. Methods for chilling a natural gas stream. The methods comprise: introducing a natural gas stream to an expander; obtaining an expanded natural gas stream from an outlet of the expander, the expanded natural gas stream having a lower temperature and a lower pressure than does the natural gas stream; introducing at least a portion of the expanded natural gas stream to a heat exchanger, the heat exchanger promoting indirect thermal communication between the expanded natural gas stream or a portion thereof and an external refrigerant circulating through the heat exchanger by way of a cooling loop; wherein the cooling loop comprises at least one compressor, and the expander directly or indirectly supplies at least a portion of an amount of power needed to operate the at least one compressor; obtaining a chilled natural gas stream from an outlet of the heat exchanger; introducing the chilled natural gas stream to a cold separator; and obtaining from the cold separator a further chilled natural gas stream as an overhead stream and a first condensed liquid stream as a bottoms stream.

B. Systems for chilling a natural gas stream. The systems comprise: an expander configured to receive a natural gas stream; a heat exchanger in fluid communication with an outlet of the expander and configured to receive an expanded natural gas stream therefrom, an external refrigerant circulating through the heat exchanger by way of a cooling loop having at least one compressor located therein, the external refrigerant being in indirect thermal communication with the expanded natural gas stream to produce a chilled natural gas stream; wherein the expander directly or indirectly supplies at least a portion of an amount of power needed to operate the at least one compressor; and a cold separator in fluid communication with an outlet of the heat exchanger and configured to receive the chilled natural gas stream from the heat exchanger and to discharge a further chilled natural gas stream as an overhead stream and a first condensed liquid stream as a bottoms stream.

Embodiment A may have one or more of the following additional elements in any combination:
Element 1: wherein the expanded natural gas stream passes through a warm separator before being introduced to the heat exchanger, an overhead stream from the warm separator being introduced to the heat exchanger as a precooled natural gas stream.
Element 2: wherein a bottoms stream comprising a second condensed liquid stream is obtained from the warm separator.
Element 3: wherein the second condensed liquid stream is combined with the first condensed liquid stream downstream from the cold separator.
Element 4: wherein, following a startup period, the expander supplies sufficient power to operate the at least one compressor in the cooling loop without using an external power source.
Element 5: wherein the cooling loop further comprises a cooling loop separator upstream from the at least one compressor, and a condenser and a surge tank downstream from the at least one compressor, the at least one compressor receiving vaporized external refrigerant from the cooling loop separator and the surge tank receiving liquefied external refrigerant from the condenser.
Element 6: wherein the natural gas stream has a temperature ranging from about 80° F. to about 120° F. (26.7° C. to 48.9° C.) and a pressure ranging from about 400 psi to about 800 psi (2.76 MPa to 5.52 MPa).
Element 7: wherein the expanded natural gas stream has a temperature ranging from about 75° F. to about 90° F. (23.9° C. to 32.2° C.) and a pressure ranging from about 350 psi to about 750 psi (2.41 MPa to 5.17 MPa).
Element 8: wherein the chilled natural gas stream has a temperature ranging from about 60° F. to about 75° F. (15.6° C. to 23.9° C.).
Element 9: wherein the expander is operatively coupled to the at least one compressor by a shaft.

Embodiment B may have one or more of the following additional elements in any combination:
Element 10: wherein the system further comprises a warm separator in fluid communication with an outlet of the expander and configured to receive the expanded natural gas stream therefrom, a first outlet of the warm separator being configured to discharge the expanded natural gas stream from the warm separator as an overhead stream and provide the expanded natural gas stream to the heat exchanger.
Element 11: wherein a second outlet of the warm separator is configured to discharge a condensed liquid stream as a bottoms stream from the warm separator.
Element 12: wherein, following a startup period, the expander supplies sufficient power to operate the at least one compressor in the cooling loop without using an external power source.
Element 13: wherein the expander is operatively coupled to the at least one compressor by a shaft.

By way of non-limiting example, exemplary combinations applicable to A include, but are not limited to: 1 and 4; 1 and 5; 1, and 6, 7, 8, and/or 9; 1, 2, and 4; 1, 2, and 5; 1, 2, and 6, 7, 8, and/or 9; 1-4; 1-3, and 5, 1-3, and 6, 7, 8, and/or 9; 4 and 5; 4 and 6; 5, and 6, 7, 8, and/or 9; 6 and 7; 6 and 8; 6 and 9; 7 and 8; 7 and 9; and 8 and 9. By way of further non-limiting example, exemplary combinations applicable to B include, but are not limited to: 10 and 12; 10 and 13; 10-12; 10, 11, and 13; 12 and 13; and 10-13.

The present disclosure is further directed to the following non-limiting clauses:

Clause 1. A method for chilling a natural gas stream, comprising:
introducing a natural gas stream to an expander;
obtaining an expanded natural gas stream from an outlet of the expander, the expanded natural gas stream having a lower temperature and a lower pressure than does the natural gas stream;
introducing at least a portion of the expanded natural gas stream to a heat exchanger, the heat exchanger promoting indirect thermal communication between the expanded natural gas stream or a portion thereof and an external refrigerant circulating through the heat exchanger by way of a cooling loop;
   wherein the cooling loop comprises at least one compressor, and the expander directly or indirectly supplies at least a portion of an amount of power needed to operate the at least one compressor;
obtaining a chilled natural gas stream from an outlet of the heat exchanger;
introducing the chilled natural gas stream to a cold separator; and
obtaining from the cold separator a further chilled natural gas stream as an overhead stream and a first condensed liquid stream as a bottoms stream.

Clause 2. The method of clause 1, wherein the expanded natural gas stream passes through a warm separator before being introduced to the heat exchanger, an overhead stream from the warm separator being introduced to the heat exchanger as a precooled natural gas stream.

Clause 3. The method of clause 2, wherein a bottoms stream comprising a second condensed liquid stream is obtained from the warm separator.

Clause 4. The method of clause 3, wherein the second condensed liquid stream is combined with the first condensed liquid stream downstream from the cold separator.

Clause 5. The method of any one of clauses 1-4, wherein, following a startup period, the expander supplies sufficient power to operate the at least one compressor in the cooling loop without using an external power source.

Clause 6. The method of any one of clauses 1-5, wherein the cooling loop further comprises a cooling loop separator upstream from the at least one compressor, and a condenser and a surge tank downstream from the at least one compressor, the at least one compressor receiving vaporized external refrigerant from the cooling loop separator and the surge tank receiving liquefied external refrigerant from the condenser.

Clause 7. The method of any one of clauses 1-6, wherein the natural gas stream has a temperature ranging from about 80° F. to about 120° F. (26.7° C. to 48.9° C.) and a pressure ranging from about 4000 psi to about 8000 psi (2.76 MPa to 5.52 MPa).

Clause 8. The method of any one of clauses 1-7, wherein the expanded natural gas stream has a temperature ranging from about 75° F. to about 90° F. (23.9° C. to 32.2° C.) and a pressure ranging from about 350 psi to about 750 psi (2.41 MPa to 5.17 MPa).

Clause 9. The method of any one of clauses 1-8, wherein the chilled natural gas stream has a temperature ranging from about 60° F. to about 75° F. (15.6° C. to 23.9° C.).

Clause 10. The method of any one of clauses 1-9, wherein the expander is operatively coupled to the at least one compressor by a shaft.

Clause 11. A system comprising:
an expander configured to receive a natural gas stream;
a heat exchanger in fluid communication with an outlet of the expander and configured to receive an expanded natural gas stream therefrom, an external refrigerant circulating through the heat exchanger by way of a cooling loop having at least one compressor located therein, the external refrigerant being in indirect thermal communication with the expanded natural gas stream to produce a chilled natural gas stream;
   wherein the expander directly or indirectly supplies at least a portion of an amount of power needed to operate the at least one compressor; and
a cold separator in fluid communication with an outlet of the heat exchanger and configured to receive the chilled natural gas stream from the heat exchanger and to discharge a further chilled natural gas stream as an overhead stream and a first condensed liquid stream as a bottoms stream.

Clause 12. The system of clause 11, further comprising:
a warm separator in fluid communication with an outlet of the expander and configured to receive the expanded natural gas stream therefrom, a first outlet of the warm separator being configured to discharge the expanded natural gas stream from the warm separator as an overhead stream and provide the expanded natural gas stream to the heat exchanger.

Clause 13. The system of clause 12, wherein a second outlet of the warm separator is configured to discharge a condensed liquid stream as a bottoms stream from the warm separator.

Clause 14. The system of any one of clauses 11-13, wherein, following a startup period, the expander supplies sufficient power to operate the at least one compressor in the cooling loop without using an external power source.

Clause 15. The system of any one of clauses 11-14, wherein the expander is operatively coupled to the at least one compressor by a shaft.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

The invention claimed is:

1. A method for chilling a natural gas stream, comprising:
introducing a natural gas stream to an expander;
obtaining an expanded natural gas stream from an outlet of the expander, the expanded natural gas stream having a lower temperature and a lower pressure than does the natural gas stream;
introducing at least a portion of the expanded natural gas stream to a heat exchanger, the heat exchanger promoting indirect thermal communication between the expanded natural gas stream or a portion thereof and an external refrigerant circulating through the heat exchanger by way of a cooling loop;
wherein the cooling loop comprises at least one compressor, and the expander directly or indirectly supplies at least a portion of an amount of power needed to operate the at least one compressor;
obtaining a chilled natural gas stream from an outlet of the heat exchanger;
introducing the chilled natural gas stream to a cold separator; and
obtaining from the cold separator a further chilled natural gas stream as an overhead stream and a first condensed liquid stream as a bottoms stream.

2. The method of claim 1, wherein the expanded natural gas stream passes through a warm separator before being introduced to the heat exchanger, an overhead stream from the warm separator being introduced to the heat exchanger as a precooled natural gas stream.

3. The method of claim 2, wherein a bottoms stream comprising a second condensed liquid stream is obtained from the warm separator.

4. The method of claim 3, wherein the second condensed liquid stream is combined with the first condensed liquid stream downstream from the cold separator.

5. The method of claim 1, wherein, following a startup period, the expander supplies sufficient power to operate the at least one compressor in the cooling loop without using an external power source.

6. The method of claim 1, wherein the cooling loop further comprises a cooling loop separator upstream from the at least one compressor, and a condenser and a surge tank downstream from the at least one compressor, the at least one compressor receiving vaporized external refrigerant from the cooling loop separator and the surge tank receiving liquefied external refrigerant from the condenser.

7. The method of claim 1, wherein the natural gas stream has a temperature ranging from about 80° F. to about 100° F. (26.7° C. to 37.8° C.) and a pressure ranging from about 400 psi to about 800 psi (2.67 MPa to 5.52 MPa).

8. The method of claim 1, wherein the expanded natural gas stream has a temperature ranging from about 75° F. to about 90° F. (23.9° C. to 32.2° C.) and a pressure ranging from about 350 psi to about 750 psi (2.41 MPa to 5.17 MPa).

9. The method of claim 1, wherein the chilled natural gas stream has a temperature ranging from about 60° F. to about 75° F. (15.6° C. to 23.9° C.).

10. The method of claim 1, wherein the expander is operatively coupled to the at least one compressor by a shaft.

11. A system comprising:
an expander configured to receive a natural gas stream;
a heat exchanger in fluid communication with an outlet of the expander and configured to receive an expanded natural gas stream therefrom, an external refrigerant circulating through the heat exchanger by way of a cooling loop having at least one compressor located therein, the external refrigerant being in indirect thermal communication with the expanded natural gas stream to produce a chilled natural gas stream;
wherein the expander directly or indirectly supplies at least a portion of an amount of power needed to operate the at least one compressor; and
a cold separator in fluid communication with an outlet of the heat exchanger and configured to receive the chilled natural gas stream from the heat exchanger and to discharge a further chilled natural gas stream as an overhead stream and a first condensed liquid stream as a bottoms stream.

12. The system of claim 11, further comprising:
a warm separator in fluid communication with an outlet of the expander and configured to receive the expanded natural gas stream therefrom, a first outlet of the warm separator being configured to discharge the expanded natural gas stream from the warm separator as an overhead stream and provide the expanded natural gas stream to the heat exchanger.

13. The system of claim 12, wherein a second outlet of the warm separator is configured to discharge a condensed liquid stream as a bottoms stream from the warm separator.

14. The system of claim 11, wherein, following a startup period, the expander supplies sufficient power to operate the at least one compressor in the cooling loop without using an external power source.

15. The system of claim 11, wherein the expander is operatively coupled to the at least one compressor by a shaft.
